(19) United States
(12) Patent Application Publication
(10) Pub. No.: US 2019/0340760 A1
(43) Pub. Date: Nov. 7, 2019

(54) SYSTEMS AND METHODS FOR MONITORING ORAL HEALTH

(71) Applicant: Barking Mouse Studio, Inc., San Francisco, CA (US)

(72) Inventors: Danielle Swank, San Francisco, CA (US); James Fleming, San Francisco, CA (US)

(21) Appl. No.: 16/398,808

(22) Filed: Apr. 30, 2019

Related U.S. Application Data
(60) Provisional application No. 62/666,690, filed on May 3, 2018.

(51) Int. Cl. G06T 7/00; G06N 3/08; G06N 3/04; G06T 7/73; G06T 7/10

(52) U.S. Cl. CPC G06T 7/0014; G06N 3/08; G06N 3/0454; G06T 2207/30036; G06T 7/10; G06T 2207/20084; G06T 2207/20081; G06T 7/74

(57) ABSTRACT

Disclosed are methods and systems for monitoring oral health. In one embodiment, a handheld device is provided which is capable of capturing and transmitting images of an oral cavity. The handheld device can include non-image-based sensors, which can measure parameters indicative of oral health. The image and non-image data are used as inputs of a machine learning module to identify oral health issues.

### CROSS-REFERENCE TO RELATED APPLICATIONS

This application claims the benefit of U.S. Provisional Patent Application No. 62/666,690, filed May 3, 2018, which is hereby incorporated by reference in its entirety.

### FIELD

This invention relates generally to methods and systems for monitoring oral health and diagnosing oral health issues, particularly an oral health monitoring system utilizing one or more light sources and a camera to monitor oral health and detect issues.

### DESCRIPTION OF THE RELATED ART

Most individuals care about their oral health. Some visit their dentists on the recommended semi-annual bases. However, such frequency of dental health monitoring may not be enough to timely detect and address dental health issues. Additionally, failure to timely detect oral health issues can lead to expense and pain which might have otherwise been avoided if in-home or convenient oral health monitoring were available. Consequently, there is a need for in-home convenient oral health monitoring systems that can be used by individuals to help monitor and timely detect oral health issues.

Additionally, available oral health monitoring systems are sometimes invasive. For example, X-ray imaging is used to detect oral health issues, but patients and dentists may be hesitant to use them for fear of side-effects of radiation. X-rays and other available monitoring systems require visiting a dental office. For example, in-office dental cameras, manual inspection by a trained dentist, plaque detecting dye, PH strips and dental lasers exist to assist in detecting oral health issues, but these treatments are often not conveniently available at home for a monitoring and early detection system usable by both dental care professionals and patients alike.

Electric toothbrushes exist that can pair with a software application, but these devices do little more than track time spent brushing and encourage users to brush more. Furthermore, visits to dentists and undergoing dental treatment can be unpleasant for some patients because of expense, anxiety, or pain. Monitoring and early detection through a convenient device can alleviate such issues and provide data to both patients and dentists to address oral health issues in a timely and cost-effective manner.

### SUMMARY

One embodiment relates to an oral health monitoring system. The oral health monitoring system may have one or more light sources, a camera, and a controller configured to control operations of the one or more light sources and the camera to obtain one or more images of a user's oral cavity. A transmitter may be configured to transmit the one or more images. A machine learning module may be configured to receive the one or more images from the transmitter and identify oral health issues in the oral cavity based at least partly on analyzing the one or more images.

In an embodiment, the oral health monitoring system may include a PH sensor, and the controller may be configured to control operations of the PH sensor to obtain PH data of the oral cavity and the transmitter is configured to transmit the PH data and the machine learning module is configured to identify oral health issues based at least partly on analyzing the PH data.

In an embodiment, the machine learning module is configured to use a neural network, the one or more images comprise one or more channels, and the channels and PH data are passed to the machine learning module.

In some embodiments, the image channels are analyzed by a neural network and the PH data is analyzed by a first machine learning model and the output of the neural network and first machine learning model are analyzed by a second machine learning model.

In an embodiment, the controller captures one or more images with the camera and each image is taken after the controller turns on one of the one or more light sources and turns off the remaining light sources.

In an embodiment, the one or more light sources each emit light at one of ultraviolet, near infrared, and visible wavelengths.

In an embodiment, the machine learning module may comprise image segmentation, neural networks, deep learning, convolutional neural network (CNN), capsule networks, fully connected attention layers, and recurrent neural network (RNN) when analyzing the one or more images.

In an embodiment, the one or more images are taken over a period of time and the machine learning module is configured to reconstruct a progression of state of health of the oral cavity over the period of time or identify oral health issues based at least partly on comparing images of same areas in the oral cavity taken at different times over the period of time or by identifying changes in the one or more images of the same areas in the oral cavity taken over the period of time.

In some embodiments, the machine learning module reports identification of oral health issues with a confidence measure, where the confidence measure may be generated using Bayesian uncertainty, Monte-Carlo dropout, or aleatoric uncertainty.

In an embodiment, the machine learning module performs image segmentation on the one or more images and classifies pixels of the one or more images into oral health state categories based on identification of oral health issues, and the machine learning module performs object detection based on the output of image segmentation.

In an embodiment, the one or more images comprise a plurality of frames in temporal sequence and the machine learning module is configured with a temporal machine learning model to process the one or more images and identify oral health issues.

In some embodiments, one or more image channels may be stacked and passed as input to a neural network.

In an embodiment, non-image based data may be added as an image channel and passed as input to a neural network.

In an embodiment, image channels are input to a first neural network, non-image-based data is input to a second neural network, and the outputs of the first neural network and second neural network are input to a third neural network to identify oral health issues in the oral cavity.

In an embodiment, the one or more images include images from visible light, images from UV light, and images from infrared light. The visible light images are input to a first neural network, the UV light images are input to a second neural network, and the infrared images are input to a third neural network. The outputs of the first, second, and third neural networks are input to fourth neural network to identify oral health issues in the oral cavity.

### BRIEF DESCRIPTION OF THE DRAWINGS

These drawings and the associated description herein are provided to illustrate specific embodiments of the invention and are not intended to be limiting.

FIG. 1 illustrates an oral health system according to an embodiment.

FIG. 2 illustrates a block diagram of portions of the oral health system of FIG. 1.

FIG. 3 illustrates a block diagram of an example convolutional neural network used to analyze oral health data and identify oral health issues.

FIG. 4 illustrates a block diagram of an example machine learning module which can be used to process the collected oral health data and identify one or more oral health issues.

FIG. 5 illustrates a block diagram of an alternative machine learning module which can be used to process the collected oral health data and identify one or more oral health issues.

FIG. 6 is a flow chart of a process of identifying oral health issues according to an embodiment.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail.

The term “about” as used herein refers to the ranges of specific measurements or magnitudes disclosed. For example, the phrase “about 10” means that the number stated may vary as much as 1%, 3%, 5%, 7%, 10%, 15% or 20%. Therefore, at the variation range of 20% the phrase “about 10” means a range from 8 to 12.

When the terms “one”, “a” or “an” are used in the disclosure, they mean “at least one” or “one or more”, unless otherwise indicated.

The term “illuminating” can refer to lighting a scene, for example an oral cavity, with visible or invisible light (such as light in ultra violet (UV), infrared (IR) or near infrared (NIR) wavelengths). NIR is a part of the IR spectrum that is closest to visible light, and, thus, NIR is a form of IR light.

Communication interfaces can communicate data using one or more wireless communication protocols such as Bluetooth, Bluetooth Low Energy (BLE), ZigBee, Wi-Fi, 802.11 protocols, Infrared (IR), Radio Frequency (RF), 2G, 3G, 4G, etc., and/or wired protocols and media. In some aspects and/or in some parts a communication interface can communicate via a communication platform, which may include one or a combination of the following: an Internet connection, such as a local area network (LAN), a wide area network (WAN), a fiber optic network, internet over power lines, a hard-wired connection (e.g., a bus), and the like, or any other kind of network connection. Communication platform may be implemented using any combination of routers, cables, modems, switches, fiber optics, wires, radio (e.g., microwave/RF links), and the like. Further, communication platform may be implemented using various wireless standards, such as Bluetooth®, BLE, Wi-Fi, 3GPP standards (e.g., 2G GSM/GPRS/EDGE, 3G UMTS/CDMA2000, or 4G LTE/LTE-U), etc. Upon reading the present disclosure, one of skill in the art will recognize other ways to implement communication platform for facilitating communications between the various parts of the described system.

The term “processor” can refer to various microprocessors, controllers, and/or hardware and software optimized for loading and executing software programming instructions or processors including graphical processing units (GPUs) optimized for handling high volume matrix data related to image processing.

Non-invasive and convenient oral health monitoring devices can be implemented by obtaining images of the teeth and oral cavity when illuminated by a light source, which may emit light at one of a plurality of wavelengths or wavelength ranges. The data from the images can be combined with data from other oral health monitoring sensors (e.g., a PH measurement sensor) to help in oral health monitoring and disease diagnosis. Additionally, machine learning can be used to process the image-based and non-image-based oral health data and identify oral health issues. For example, neural networks such as convolutional neural networks can be designed and trained to perform image segmentation and identify oral health issues by classifying pixels in an oral image. In other embodiments, object detection can be performed on images and areas of disease or irregularity pointed out.

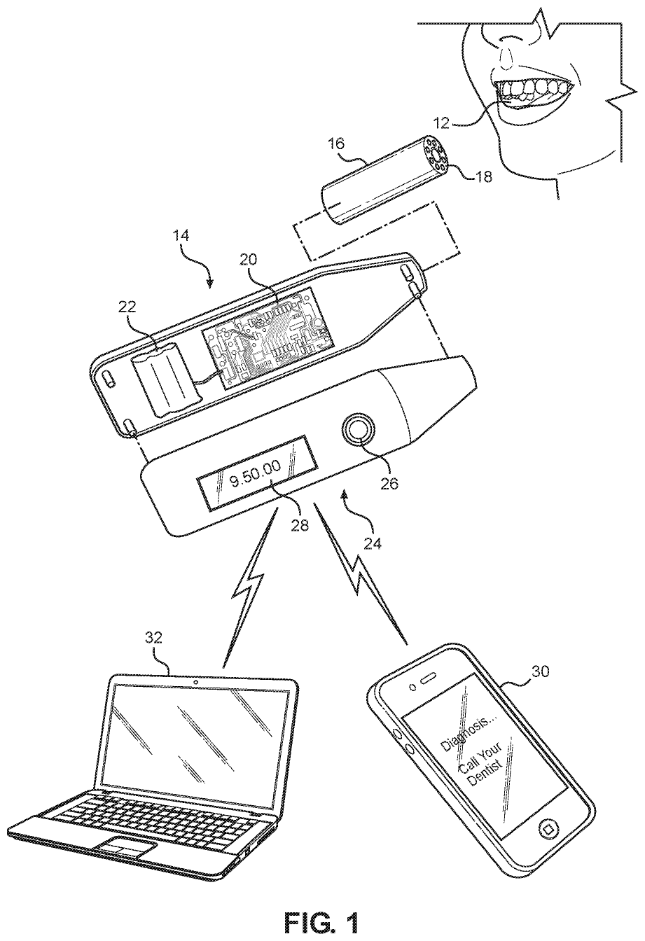

FIG. 1 illustrates an oral health system 10 according to an embodiment. The system can be used to monitor oral health of an oral cavity 12, for example a human's or a pet's mouth. The system 10 can include a handheld device 14. The handheld device 14 can include some of the hardware functionality of the system 10. The handheld device 14 can be inserted in the oral cavity 12 to collect oral health data. The handheld device 14 can include an interchangeable head unit 16. The head unit 16 can include sensors 18. The sensors 18 can include image-based and/or non-image-based sensors. In some embodiments the head unit 16 can be interchangeable or used in addition with another head unit outfitted with a motorized toothbrush. The handheld device 14 can include a circuit board 20 to control the operations of the head unit 16 and the sensors 18. An energy storage device or battery 22 can provide power to the handheld device 14. The energy storage 22 can be a secondary battery or one or more batteries.

The handheld device 14 can include a housing to encapsulate the printed circuit board 20, the battery 22 and other components of the device. The handheld device 14 can include a cover or housing enclosure cap 24. The cover 24 can include one or more external buttons 26 for an operator of the handheld device 14 to start/stop and/or turn on/off the operations of the device 14. The cap 24 can include a display 28 to display data related to the operations of the device. In some embodiments, a housing of the device 14 can be a unitary piece including the cap 24 and encapsulating the internal components such as printed circuit board 20 and battery 22.

The device 14 can pair to and communicate with one or more computing devices, such as a mobile phone, smart phone, tablet, smart watches, laptop, desktop computer, server computer, computer device running a software API, or similar devices running an oral health application 30 and/or a website 32. The operator of the handheld device 14 can view the data collected by the handheld device 14 and oral health monitoring results generated by the system 10.

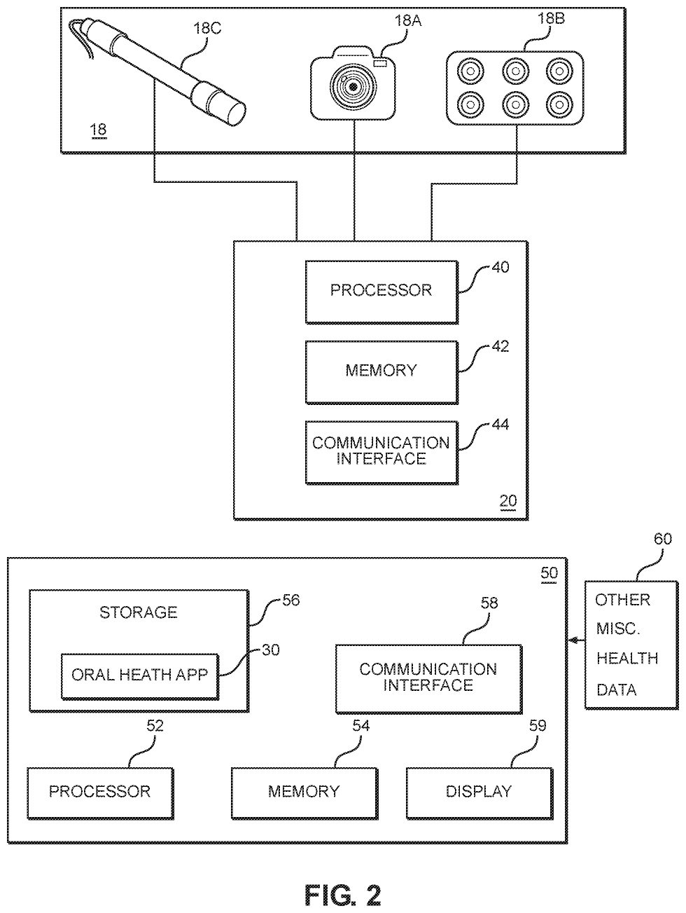

FIG. 2 illustrates a block diagram of portions of the oral health system 10. The printed circuit board (PCB) 20 can include hardware and software to control the operation of one or more sensors 18. In one embodiment, sensors 18 can include an image-based sensor 18a such as a camera, one or more light emitting diodes (LEDs) 18b and a non-image-based sensor 18c. The non-image-based sensor 18c can include a PH sensor capable of measuring how acidic or basic the oral cavity 12 may be. PH measurements can be relevant to oral health state. For example, if it's known that the oral cavity 12 has a generally high PH level, it may be likely that some borderline system-identified cavities may be false positives.

The image-based sensor 18a (e.g., a camera) and 18b can be one component or they can be provisioned as separate components. The camera 18a can be a camera capable of recording images captured at scenes illuminated with lights of varying wavelength. In one embodiment, the camera 18a is a conventional digital camera, such as a digital camera designed for integration into a smart phone or other mobile device. Inexpensive conventional digital cameras may be used to keep the cost of the device 14 low, and some conventional digital cameras have the capability to record light both inside and outside the visible spectrum. For example, an exemplary digital camera may have the capability for detecting light in the range 350 nm to 1000 nm or from 400 nm to 700 nm. The term “visible light” camera may be used to refer to a conventional digital camera that captures visible light and some light at the ultraviolet and infrared wavelengths. For example, in one embodiment, the LEDs 18b are capable of producing light of varying wavelengths, such as ultraviolet (e.g., UVA), IR or NIR, and visible light. Because the mouth is typically dark, illuminating the mouth with a single light source operating in a particular range of the spectrum and photographing the mouth with a conventional digital camera during the illumination produces an image with image data produced primarily from the selected wavelength.

The PCB 20 can include processor 40, memory 42 and communication interface 44. The processor 40 can control the operations of the sensors 18. The memory 42 can be a short-term or long-term storage device and can be used to temporarily store data collected by the sensors 18. The communication interface 44 can transmit the oral health data collected by the sensors 18 to a computing device 50. The computing device 50 can be a mobile, or stationary computing device. Examples of computing device 50 can include a smart mobile phone, a laptop, a tablet, smart watch, a remote or local server, a desktop computer and similar devices.

Computing device 50 can include a processor 52, memory 54, storage 56, communication interface 58 and display 59. The storage 56 can store the programming instructions for the oral health application 30. The processor 52 can include a Central Processing Unit (CPU) and/or a graphical processing unit (GPU). GPUs can be optimized to handle image processing tasks associated with the processing of data from the image-based sensor 18a. The processor 52 can load the programming instructions for running the oral health application 30 from the storage 56 to the memory 54. The computing device 50 can communicate with device 14 using communication interface 58 to receive oral health data collected by sensors 18. Communication interfaces 44 and 58 can utilize a wired, or wireless communication medium to transfer oral health data. The display 59 can be a touch display to facilitate interacting with the system 10 and to display the result of diagnosis and oral health monitoring to the operator of the system 10.

In some embodiments, oral health-related data 60 can be provided to the oral health application 30 to improve or assist in oral health monitoring. For example, the operator of the system 10 can input oral health data, history, demographics and other related information.

The processor 40 can control the light source 18b illuminating the oral cavity 12 with lights of varying wavelengths. The processor 40 can also control the camera 18a to capture images of the oral cavity 12. The interior of the oral cavity is dark. In one embodiment, the processor 40 can turn on an LED amongst the LEDs 18b corresponding to a wavelength (e.g., UVA) and/or power, turn off the remaining LEDs and trigger the camera 18a to capture an image of the oral cavity. The processor 40 can cycle through the other LEDs 18b repeating the process and capturing images of varying wavelengths. As described in some embodiments, the camera 18a and its light source 18b can be a single component. In some embodiments, the camera 18a can be a conventional digital camera with a single image sensor that captures light across the visible spectrum and at least to some extent in the ultraviolet and infrared spectrums. The image sensor may have millions or tens of millions or more pixels of resolution. By varying the single LED out of the LEDs 18b used for illumination, an image taken at a desired wavelength is captured by the camera 18a.

In one embodiment, a first LED, second LED, and third LED are provided that produce light at non-overlapping wavelength ranges, for example non-overlapping ranges of infrared, visible, and ultraviolet light, and the first, second, and third LED begin in the off state. A first LED at a first wavelength or wavelength range is turned on and camera 18a captures an image. Then, the first LED is turned off. A second LED at a second wavelength or wavelength range is turned on and camera 18a captures an image. Then, the second LED is turned off. A third LED at a third wavelength or wavelength range is turned on and camera 18a captures an image. Then, the third LED is turned off. The device 14 then repeats the cycle starting with the first LED, and each cycle may occur in rapid succession. In some embodiments, an entire cycle of three images may be taken in less than 1 second, less than 2 seconds, less than 3 seconds, less than 4 seconds, or less than 5 seconds. The oral cavity is illuminated in a single wavelength or wavelength range for each digital photograph.

In dentistry, various oral health data can be obtained when an oral cavity such as oral cavity 12 is illuminated with lights of varying wavelength and/or power. X-ray imaging can be used. However, non-invasive diagnostic images can also be obtained with non-X-ray light. For example, illuminating oral cavity 12 with 350-405 nm UVA can produce images that show fluorescing plaque bacteria. Illuminating oral cavity 12 with 750-1400 nm near infrared (NIR) can produce images containing decalcification information. Illuminating oral cavity 12 with 4000-5000 watt (W) neutral white light can produce images containing color information. In one embodiment, 385 nm UVA, 1300 nm infrared and 4800 W visible light are used.

The images obtained from various wavelengths and/or power levels can be combined with data obtained from non-image-based sensors and data from other sources, for example, by user input or from a user's profile. A machine learning module can analyze the oral health data and identify various oral health issues and their precursors. Oral health issues identifiable by system 10 can include, for example, existence of plaque, cavity, gum recession, tooth coloring indicative of oral health disease and/or other oral health issues.

Various machine learning techniques can be used to analyze sensor-collected and non-sensor collected oral health data to identify oral health issues and their precursors. These can, for example, include image segmentation with neural networks (NNs), object detection (with or without using neural networks), deep neural networks, convolutional neural networks (CNNs), capsule networks, fully connected attention layers, and recurrent neural networks (RNNs).

Convolutional neural networks (CNNs) are deep learning neural networks that can be used to analyze image-based and non-image-based sensor data. CNNs consist of an input and an output layer as well as one or more hidden layers. Layers used in a CNN can include convolutional layers, down-sampling or pooling layers, normalization layers, fully connected layers and others.

In one embodiment image segmentation using neural networks, such as CNNs, can be employed to classify pixels in an image. Various classifications can be implemented. For example, some classifications include classifying existence or non-existence of various oral health issues (e.g., tooth decay). Others can include classification as well as a rating (e.g., gum health on a scale of one to seven, one to nine, one to ten, or other scales).

Some machine learning techniques can be optimized for detecting the presence or absence of an oral health issue or to count the instances of a countable oral health issue but may be inadequate for describing the placement and location of the oral health issue. In these cases, various machine learning techniques can be combined or performed in tandem to obtain both quantity, quality and placement information from the collected oral health data. For example, image segmentation can detect existence of tooth decay and the number of tooth decays (e.g., the oral cavity 12 may be detected to have 5 instances of tooth decay), but image segmentation may not be adequate or optimized for stating where the detected tooth decays exist in the oral cavity 12. An object detection process can be performed in combination with image segmentation to also identify the location of detected tooth decays.

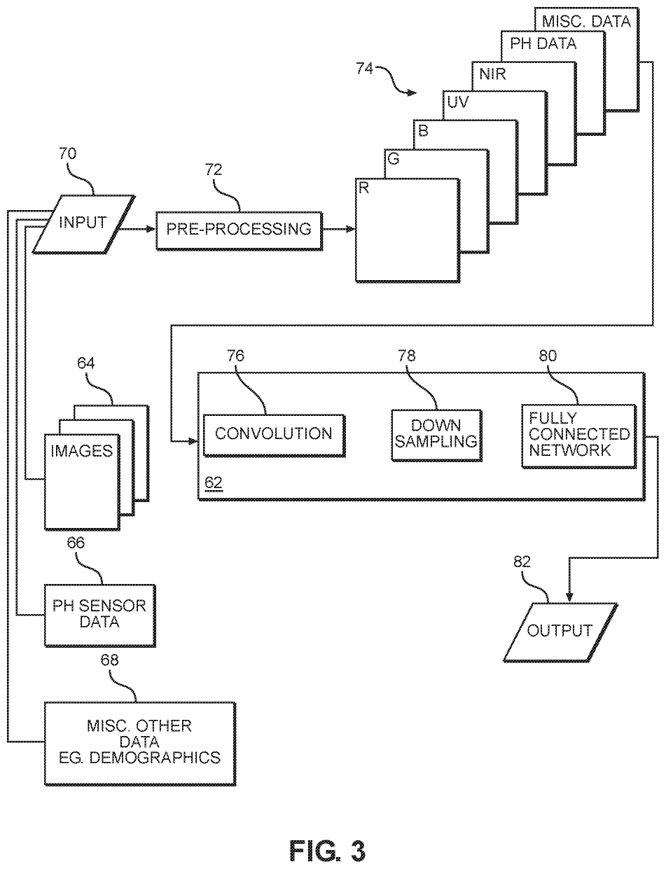

FIG. 3 illustrates a block diagram of a neural network used to analyze oral health data and identify oral health issues. Various collected oral health data is fed to the network as inputs 70. Inputs can include image-based data, such as images 64, non-image-based data, such as PH sensor data 66 and non-sensor-based oral health data 68 (e.g., demographics, user history and profile data, etc.). The inputs 64, 66 and 68 may undergo some preprocessing 72 before proceeding into a neural network (NN) 62, which may be a CNN. Preprocessing 72 can for example include cropping unneeded areas of images, background or border deletion, various normalization functions or other preprocessing as the design of NN 62 may indicate.

Next in blocks 74, the various image channels of the images 64 can be stacked as inputs to the NN 62. In the example of FIG. 3, images are RGB images and those channels are stacked as inputs to the NN 62. Other collected oral health data can also be stacked as additional image channels and inputted into the NN 62. For example, in addition to R, G and B channels corresponding to images captured using visible light, the input of the NN 62 can include channels corresponding to images captured using UV light and/or NIR light, PH sensor data and other miscellaneous oral health related data. The input channels can go through various NN layers such as convolution 76, down-sampling or pooling 78 and fully connected network 80 to produce output 82. As described, output 82 can be a classification of a pixel in an image of the oral cavity 12, a classification of an area of interest in the image and/or a classification of a pixel, region and a rating.

The building blocks of NN 62 are not limited to the blocks described above. A person of ordinary skill in the art can envision a different number of layers or different arrangement of layers via experimentation with the available oral health data to design the layers of NN 62 or identify an optimum technique for finding filter weights and other parameters.

In some embodiments, a confidence measure module can be added to state a confidence measure regarding any identified oral health issue. The confidence measure can be used, for example, to decide whether visiting a dentist is warranted. For example, a 25% confidence in a tooth decay detection may not be enough for some users to schedule an appointment with their dentists. Conversely, a decay detection with 98% confidence may persuade the user to visit her dentist. The confidence measure module can be implemented with various techniques including Bayesian uncertainty, Monte-Carlo dropout or aleatoric uncertainty or other methods.

In some embodiments, the images 64 can be frames extracted from a video or may be still images taken in close sequence such as within seconds or fractions of a second. For example, the camera 18a can be capable of capturing video or rapid sequences of photographs of the oral cavity 12. The video image frames or sequence of still images can be inputted to a temporal convolutional network (3D) which uses different methods of merging CNN features from different image frames over time. Such methods can be used to compare different images of the same area within oral cavity 12 from different days to track changes. Such changes can indicate the development or existence of an oral health issue.

Similar to processing video, in some embodiments, still images of oral cavity 12 taken over a period of time (e.g., taken 2 days, or a week, or a month apart) can be used to compare and detect changes in the same area of oral cavity 12 over the period of time. Changes over time can be indicative of oral health issues.

In some embodiments, the historical oral health data can be used to reconstruct a state of health of the oral cavity 12 including present and historical states, for example, via a visual representation such as animation, use of colors, texts, or other user-friendly indications to illustrate the oral health of the oral cavity 12 over time.

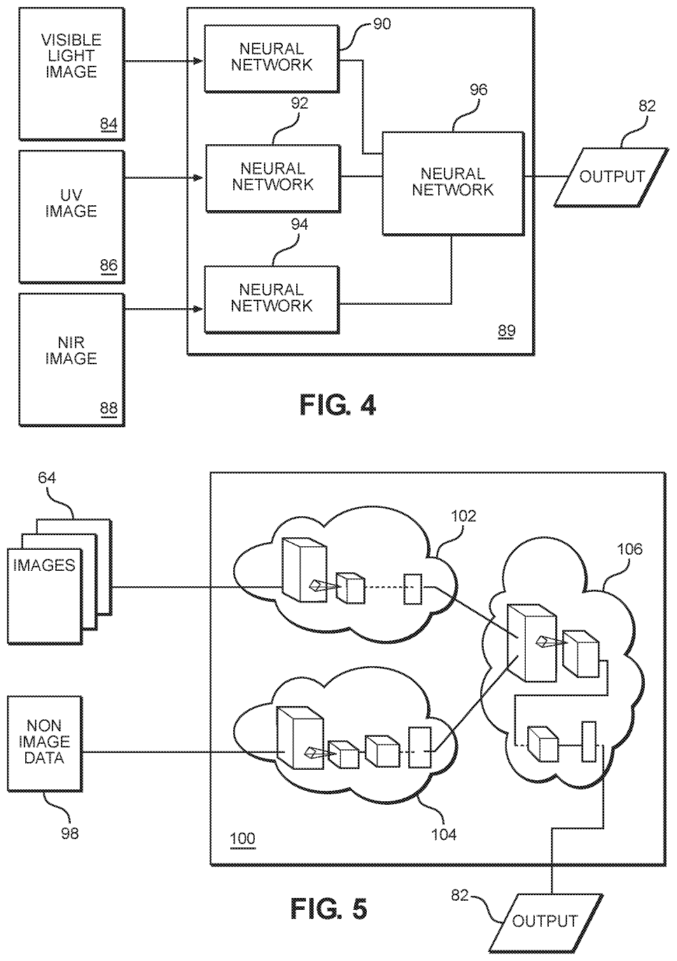

FIG. 4 illustrates a block diagram of a machine learning module 89 which can be used to process the collected oral health data and identify one or more oral health issues. The machine learning module 89 can be a NN, such as for example a CNN, and can be used to combine various image-based sensor data at the feature level within the NN 89, as opposed to combining them at the input level. The NN 89 can include NNs 90, 92 and 94, which may optionally be CNNs. The images captured with visible light 84 can be processed through the NN 90, the images captured with UV light can be processed through the NN 92 and the images captured with infrared light can be processed through the NN 94. The outputs of the NNs 90, 92 and 94 (feature level) can be fed through a NN 96 designed to analyze NN-processed image-based sensor data to identify oral health issues and generate output 82 identifying oral health issues.

FIG. 5 illustrates a block diagram of another machine learning module 100 which can be used to process the collected oral health data and identify one or more oral health issues. The machine learning module 100 can be a NN, such as for example a CNN, and can be used to combine image-based sensor data and non-image-based sensor data at the feature level within the NN 100, as opposed to combining the image and non-image-based data at the input level. The NN 100 can include NNs 102, 104 and 106, which may optionally be CNNs. The images 64 can be fed through a NN 102 optimized to process images. The image channels of the images 64 (e.g., RGB) can be stacked and fed through the input of the NN 102. Similar to the embodiment of FIG. 3, the images captured by the camera during illumination at different wavelengths, such as UV and IR light, can be fed through the NN 102 as image channels stacked on top of the visible light image channels. In some embodiments, the images taken at the different wavelengths may all be stored as RGB images. The non-image data can be fed through the input of NN 104. The outputs of the NNs 102 and 104 (feature level) can be fed through a global NN 106 designed to analyze the NN-processed image-based and non-image-based data and generate output 82 identifying oral health issues.

Machine learning techniques including NN and CNN can often be optimized using experimentation. Additionally, a challenge in optimizing machine learning techniques is lack of sufficient data to train the system models. The various embodiments described herein can be employed in parallel or experimented with among a collection of users to find or to train the optimal machine learning module. Arrangement of layers and/or machine learning parameters can be optimized with oral health data obtained from a group of users. Further, the described machine learning modules or other applicable machine learning techniques and models can be trained using publicly or privately available data. For example, appropriate user permissions can be obtained and the collection of data among the users can be used to train the described models to identify oral health issues.

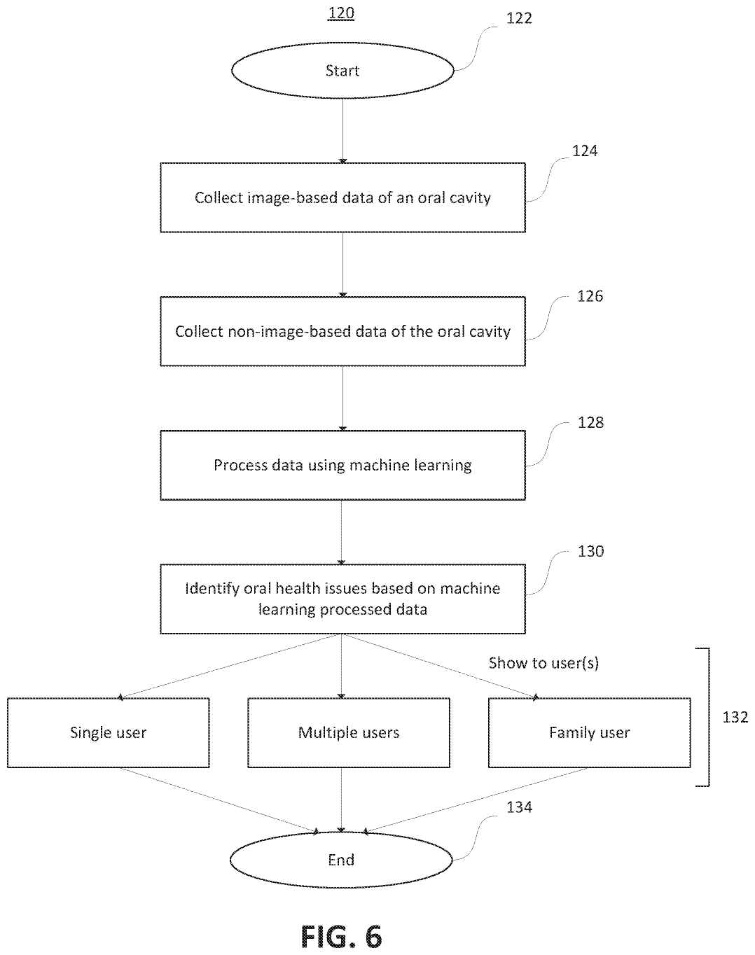

FIG. 6 is a flow chart of a process 120 of identifying oral health issues using an embodiment. The process starts at step 122. The process then moves to the step 124 collecting image-based data of an oral cavity. The process then moves to the step 126 collecting non-image-based data of the oral cavity. The process then moves to the step 128 processing the image-based and non-image-based data using machine learning. The process then moves to the step 130 identifying oral health issues in the oral cavity based at least partly on the processing of the data using machine learning. The process then moves to the step 132 of showing oral health data to the user, a caregiver, or a dental practitioner. The oral health data may be shown to a single user, such as the patient; to multiple users, such as a patient and a dental practitioner; or a family user, such as a parent reviewing data for her children. The oral health data may include raw data, extracted data, and output data produced by machine learning and other processing. The process ends at the step 134.

What is claimed is:

1. An oral health monitoring system comprising:
one or more light sources;
a camera;
a controller configured to control operations of the one or more light sources and the camera to obtain one or more images of an oral cavity;
a transmitter configured to transmit the one or more images;
a machine learning module configured to receive the one or more images from the transmitter and identify oral health issues in the oral cavity based at least partly on analyzing the one or more images.

2. The system of claim 1, further comprising a PH sensor, and wherein the controller is further configured to control operations of the PH sensor to obtain PH data of the oral cavity and the transmitter is further configured to transmit the PH data and the machine learning module is further configured to identify oral health issues in the oral cavity based at least partly on analyzing the PH data.

3. The system of claim 2, wherein the machine learning module comprises an input and is configured to use a neural network (NN), the one or more images each comprise one or more channels, the channels are passed to the input of the machine learning module and the PH data is passed to the input of the machine learning module.

4. The system of claim 2, wherein the machine learning module is configured to use one or more neural networks (NN), the one or more images each comprise one or more channels, the image channels are analyzed through a first NN, the PH data is analyzed through a first machine learning model and the output of the NN and first machine learning model are analyzed by a second machine learning model to identify oral health issues in the oral cavity.

5. The system of claim 1, wherein the controller is further configured to capture the one or more images with the camera and each image is taken after the controller turns on one of the one or more light sources and turns off remaining light sources.

6. The system of claim 1, wherein the one or more light sources comprise light sources of varying wavelengths comprising ultraviolet (UV), near infrared (NIR) and visible light.

7. The system of claim 1, wherein the machine learning module is configured to use one or more of image segmentation, neural networks, deep learning, convolutional neural network (CNN), capsule networks, fully connected attention layers, and recurrent neural network (RNN) when analyzing the one or more images.

8. The system of claim 1, wherein the machine learning module comprises an input, the one or more images each comprise one or more channels, and the channels are passed to the input of the machine learning module.

9. The system of claim 1, wherein the one or more images are taken over a period of time and the machine learning module is further configured to reconstruct a progression of state of health of the oral cavity over the period of time or identify oral health issues based at least partly on comparing images of same areas in the oral cavity taken at different times over the period of time or by identifying changes in the one or more images of same areas in the oral cavity taken over the period of time.

10. The system of claim 1, wherein the machine learning module is further configured to report the identification of oral health issues with a confidence measure, wherein the confidence measure is generated by using Bayesian uncertainty, Monte-Carlo dropout, or aleatoric uncertainty.

11. The system of claim 1, wherein the machine learning module is further configured to perform image segmentation on the one or more images and classify pixels of the one or more images into oral health state categories based on identification of oral health issues, and the machine learning module is further configured to perform object detection based on the output of image segmentation.

12. The system of claim 1, wherein the one or more images comprise a plurality of frames in temporal sequence and the machine learning module is configured with a temporal machine learning model to process the one or more images and identify oral health issues.

13. A method of oral health monitoring comprising:
collecting image-based data of an oral cavity;
collecting non-image-based data of the oral cavity;
processing the image-based and non-image-based data using machine learning; and
identifying oral health issues in the oral cavity based at least partly on the processing of the data using machine learning.

14. The method of claim 13, wherein collecting image-based data comprises obtaining images of the oral cavity and collecting non-image-based data comprises collecting PH data of the oral cavity.

15. The method of claim 13, wherein the image-based data comprises image channels, machine learning comprises a neural network (NN) and the processing comprises stacking the image channels and passing the image channels to the NN.

16. The method of claim 13, wherein image-based data comprises image channels, machine learning comprises a neural network (NN) and the processing comprises passing the image channels to the NN and passing the non-image-based data as an image channel to the NN.

17. The method of claim 13, wherein image-based data comprises image channels, machine learning comprises one or more neural networks (NN), the processing comprises inputting the image channels to a first NN, inputting the non-image-based data into a second NN and inputting outputs of the first and second NNs through a third NN to identify oral health issues in the oral cavity.

18. The method of claim 13, wherein image-based data comprises images from visible light, images from UV light and images from infrared light, machine learning comprises one or more neural networks (NN), the processing comprises inputting the visible light images through a first neural network, inputting the UV light images through a second neural network, inputting the infrared images through a third neural network and inputting outputs of the first, second and third neural networks through a fourth neural network to identify oral health issues in the oral cavity.

19. The method of claim 13, further comprising generating a confidence measure associated with identifying oral health issues, wherein the confidence measure is based on Bayesian uncertainty, Monte-Carlo dropout, or aleatoric uncertainty.

20. The method of claim 13, wherein the image-based data and the non-image-based data are collected over a period of time and identifying the oral health issues in the oral cavity further comprises comparing the data over the period of time or is at least in part based on identifying changes in the data over the period of time.
